(19) United States
(12) Patent Application Publication
(10) Pub. No.: US 2016/0314500 A1
(43) Pub. Date: Oct. 27, 2016

(54) CONTENT SPACE EXCHANGE

(71) Applicant: Ding GU, Sewell, NJ (US)

(72) Inventor: Ding GU, Sewell, NJ (US)

(21) Appl. No.: 15/102,547

(22) PCT Filed: Dec. 8, 2014
(86) PCT No.: PCT/US14/69082

§ 371 Date: Jun. 8, 2016

Related U.S. Application Data
(60) Provisional application No. 61/913,355, filed on Dec. 8, 2013.

(51) Int. Cl. G06Q 30/02

(52) U.S. Cl. CPC G06Q 30/0273; G06Q 30/0277

(57) ABSTRACT

Systems, devices, and techniques for placing and promoting content using a content exchange system are described herein. In one aspect, one or more content space allocations associated with a first user may be received. One or more content spaces may be generated based on the received content space allocations, for example, by a host. Each of the content spaces may be associated with a number of points for each access or view of the content space based on at least one of size, location, or type of the content space. The number of points associated with each access of each of the one or more content spaces may be tracked, and at least one selection of a content space associated with a second user may be generated in proportion to the stored number of points.

### CROSS REFERENCE TO RELATED APPLICATIONS

This application claims benefit under 35 U.S.C. §119(e) of U.S. Provisional Patent Application No. 61/913,335, filed Dec. 8, 2013, the contents of which are incorporated herein by reference in its entirety.

### BACKGROUND

It is well known in the art that companies and organizations regularly place content on search engines (such as GOOGLE, YAHOO, YELP, and others), along with heavy-traffic websites, such as CNN, FACEBOOK, and the like. The current mechanisms for placing content on various web pages and search engines is time consuming, requiring a user to go through a number of steps or procedures to have content placed on web pages associated with another company, organization, etc. In addition, current content placement mechanisms usually require many communications between a company and a content promoter and/or content publisher to agree upon and place the content such that the public can see the content. Current content placement mechanisms are also, generally, very costly. Many organizations have a need for placing content on the internet, but need a more user-efficient and cost-effective medium for placing their content.

The placement of online content is a large business and is growing rapidly. Online content placement and promotion is widely used across virtually all industry sectors. Various types of internet content placement pricing models are used. Examples include CPM, or cost per mille. This refers to a set price a company pays for every 1000 displays of their message/content to potential customers. Alternatively, a CPC, or cost per click, model is used. With a CPC model, a company pays each time a website visitor clicks on a given content item. Another model is based on Cost Per Action, or CPA. Here, a company pays based on the number of users who perform a desired activity (like completing a purchase) and then the company compensates the content promoter website accordingly. Fixed cost compensation models also exist. Here, a company may pay a flat rate for the delivery of content online. Often, the content in a flat rate system are displayed for a set time period, irrespective of the number of views, clicks or actions.

Smaller entities or companies further have difficulty entering into content promotion markets, and particularly internet-based content promotion due to the prohibitive cost associated with purchasing content space from a promoter third party, etc.

### SUMMARY

Systems, devices, and methods are described herein for placing and promoting content using a content exchange system. The content exchange system or platform may enable members of a content exchange or alliance to promote themselves, their companies, etc., by exchanging content space with other members. The content exchange may eliminate the need for a third party promoter, such that a user or member of the content exchange may easily and quickly use content space of another member to promote any content of their choosing. In some cases, users of the content exchange system may provide other members content space on websites, or other spaces, associated with their own business or organizations. Members may host content of other members and use content space of other members for their own content, for example, based on a points system. In this way, members may promote content via content spaces more efficiently, for example, by taking less required steps to choose and promote content, by eliminating communications with outside promoters/publishers, and being able to promote content in a significantly shorter time period (e.g., less time in preparation). These efficiencies may be realized in a more intuitive and unified interface, reduction in network usage resulting from the elimination of communications with outside promoters, etc. Use of the content exchange or alliance may also reduce and/or eliminate many costs associated with promoting content.

In some aspects, the content exchange system may include an interface for use by third parties to use content spaces of one or more members of the content exchange. In some cases, a third party may exchange other value, besides points, for content spaces or points to use in selecting content spaces of one or more members.

In one aspect, utilization of content spaces using a content exchange system may include receiving one or more content space allocations from a first user or member via an input device, such as personal computer or other computing device. One or more content spaces may be generated based on the received content space allocations, with each content space allocation associated with a number of points based on at least one of size, location, or type of the content space. In some cases, the points associated with each content space may be based on a number of views or accesses (actual or extrapolated) of the respective content spaces. Each time a content space is accessed or viewed, the associated number of points may be given or associated with the first user. The first user may thus collect or accumulate points for views of the first user's website or other space or medium allocated for showing content of other users or members. At least one selection of a content space associated with a second user or member may then be generated in proportion to the stored number of points of the first user, and presented to the first user.

In another aspect, a host device or entity may register and associate a plurality of users or members with a content exchange system, for example, by associating each user with at least one content space. The host device may receive designations of available content spaces from a plurality of users and track a number of views or accesses of each designated content space for each user. The host device may further allocate points to users based on the tracked views of each content space. The host may then generate at least one content space selection for at least one user based on the points allocated to that user. In some cases, the host unit may additionally register one or more third parties, such as a publisher, and generate content space selections for other users based on content spaces designated by the third party. Similarly, the host device may register third party content promoters and generate one or more content space selections for the content promoters based on available content spaces associated with one or more users.

Other features of the disclosure are described below. The features, functions, and advantages that have been discussed can be achieved independently in various examples or may be combined in yet other examples, further details of which can be seen with reference to the following description and drawings.

### BRIEF DESCRIPTION OF THE DRAWINGS

The following detailed description may be better understood when read in conjunction with the appended drawings. For the purposes of illustration, various examples of aspects of the disclosure are shown in the drawings; however, the invention is not limited to the specific methods and instrumentalities disclosed.

FIG. 1 is a diagram illustrating an example network implementing a content exchange system or platform in accordance with the present disclosure.

FIG. 2 is a diagram illustrating an example user/member of a content exchange system in accordance with the present disclosure.

FIG. 3 is a block diagrams illustrating example communications between a member and a host, in accordance with the present disclosure.

FIG. 4 is a flow block diagram illustrating an example of points exchanged between multiple users of a content exchange system, in accordance with the present disclosure.

FIG. 5 is a block diagram illustrating example content spaces on a website, in accordance with the described techniques.

FIG. 6 is a block diagram illustrating example communications between a host, multiple members, and a third party via a network, in accordance with the present disclosure.

FIG. 7 is a block flow diagram illustrating a method for implementing a content exchange system in accordance with the present disclosure.

FIG. 8 is a block diagram illustrating example host and client devices in accordance with the present disclosure.

FIG. 9 is a block diagram illustrating an example computing environment for use with a content exchange system, in accordance with the present disclosure.

FIG. 10 is a diagram illustrating example communications/transactions between third party content promoters and third party publishers and members and between members using a content exchange system, in accordance with the present disclosure.

FIG. 11 is a diagram illustrating example communications/transactions between members, third party content promoters, and third party publishers and members using a content exchange system, in accordance with the present disclosure.

FIGS. 12-22 are block diagrams illustrating examples of a graphical user interface (GUI) of a content exchange system, in accordance with the present disclosure.

### DETAILED DESCRIPTION OF ILLUSTRATIVE EMBODIMENTS

Systems, devices, and methods are described herein for placing and promoting content using a content exchange system. A content exchange interface or system (e.g., a platform or network) may enable members of a content exchange or alliance to promote themselves, their companies, etc., by exchanging content space with other members. In this way, members of the content exchange or alliance may promote themselves/their business or organizations while providing a medium for other members to promote themselves in a like manner. The content exchange, as described herein, may eliminate the need for an outside entity to promote/present the content of members associated with the content exchange. The described techniques may reduce the usage of network resources, reduce content promotion costs, and reduce time spent in the selecting and arranging for presentation of content. In some cases, the content exchange may include an interface that enables members or users to quickly and efficiently designate content spaces on one or more websites or spaces associated with other members. As a result, the steps taken by a user or member to promote their own content may be significantly reduced.

In some aspects, a content exchange system, for example, including one or more computing devices, may receive an allocation of one or more content spaces available for use from a first user. In some cases, the one or more content spaces may be associated with the first member's website, or other content medium. The content exchange system may generate the allocated content spaces and allocate a number of points to each content space. The point value may be based on size, location, or type of the content space. For example, a highly visible content space, such as associated with a banner across a website, may be associated with more points than a less visible content space, for example a smaller side space. Additionally or alternatively, streaming video content may be given a higher point value than static content. The content exchange system may accumulate or tracks points for the content spaces associated with the first user, for example, each time the content space is viewed or accessed. The content exchange system may generate at least one selection of a content space associated with a second user, for example, in proportion or based on the number of points accumulated by the first user. In some cases, the content exchange system may generate selections associated with all available content spaces associated with the content exchange system regardless of whether the first user has enough points to select any given content space.

In some cases, the selection of one or more content spaces may be associated with a time period, a number of accesses, an action, or an industry. For example, the first user may select a content space of a second member on which to present content. The selection may be associated with a point value, for example, adjusted by how long the content space will be active or present the first user's content, a number of accesses of the content space, based on how many times a certain action (e.g., selecting the content within the content space) is performed, and/or an industry that the second member's content space is associated with. In some cases, the second member, and any member for that matter, may limit the type of content that is presented in the content space made available by that member. For instance, a company in one industry, such as a law firm, may not want to present content for other members in that same or similar industry, such as other law firms, on their website or other content medium. In some cases, for example to promote equity in the content exchange system, a member may not directly specify which member website on which to promote certain content.

In some aspects, a member, or a third party, may exchange other value for points to be used for content space selection, for example by purchasing points. In some cases, the content exchange system may determine what content spaces are available, for example, by keeping track of the total number of content spaces associated with the exchange system, a number of selected or active content spaces, and/or a number of free or unoccupied or un-selected content spaces. Additionally, in some cases, a user may present content on the one or more content spaces of a third party, such as a publisher, through the content exchange system based on points or a point-equivalent value.

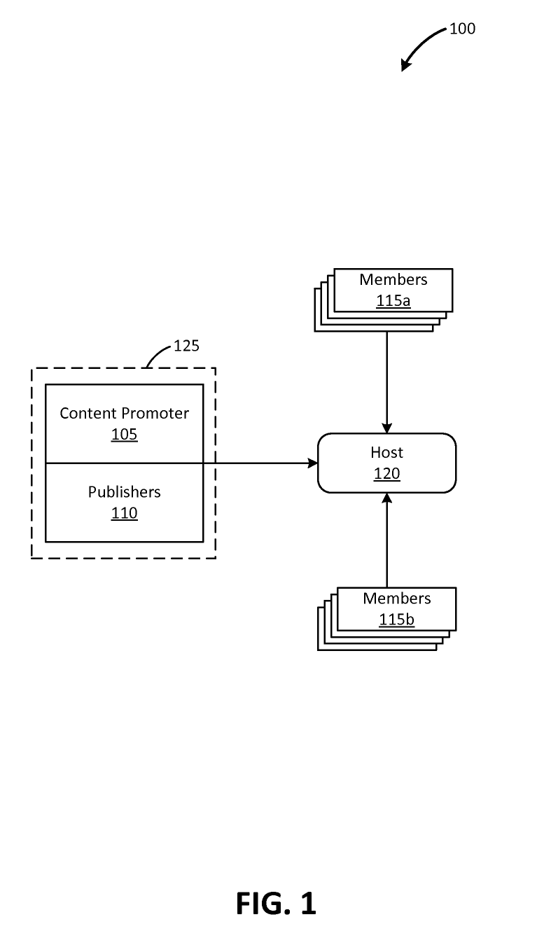

With reference to FIG. 1, a content exchange system 100, including a host 120 in communication with multiple members 115a and 115b is shown. In some aspects, the host 120 may also be in communication with one or more third parties 125, represented as content promoters 105 and publishers 110. In some cases a single third party 125 may act as both a promoter 105, for example a party seeking to promote its own content via a space/content space of another, and a publisher 110, such as a party that presents content of others, usually for value. In some cases, one or more members 115a, 115b may be small and medium-sized businesses/enterprises (SMEs).

The host 120 may organize and provide a content exchange or alliance system 100 to members 115a and 115b. The content exchange system 100 may also be referred to or include a content platform or a content network. The content exchange system 100 may provide a first member 115a with access to the content alliance, for example, to provide content space where another member 115b or multiple members may present content. In exchange for allowing other members 115 to present content, the first member may receive points or other measurable units, that may in turn be used to select content spaces of another member 115 on which to promote or present first member's 115a content. In this way, the host 120 may enable members 115a and 115b to promote content without having to go through a promoter 105 or publisher 110.

In some cases, a content promoter 105 may purchase points through the host 120 to promote content associated with the content promoter 105 on one or more content spaces associated with members 115a and/or 115b. In some examples, a publisher 110 may exchange available content space for other value, for example monetary value or access to member's 115 content spaces, etc. In this way, the content exchange 100 may interface and accommodate third parties to provide more avenues and ways to promote content.

In one example, content presented in one or more content spaces may include advertisements, for example, promoting the company or organization of a first member 115a, for example, in content spaces of another member 115b. In some cases, one or more members 115 may purchase points to be used for selecting content spaces, for example, to provide more exposure of content to increase business. In some aspects, a member 115a may purchase content space associated with a publisher 110, for example, to gain even more exposure for advertising and the like.

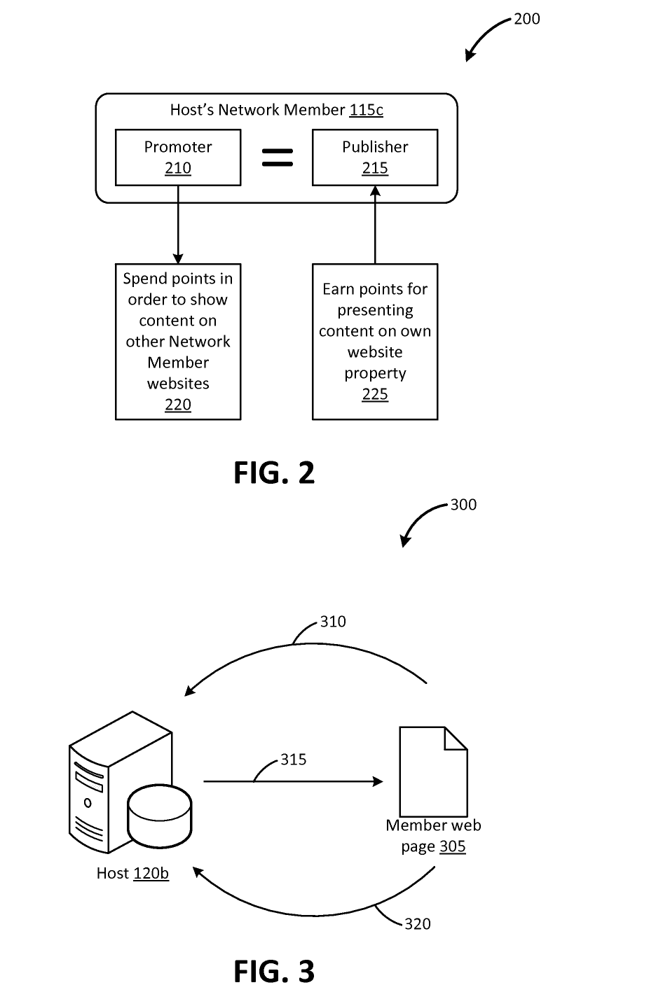

In reference to FIG. 2, a more detailed example of a member 115c associated with a content exchange or alliance system is shown. In some examples, member 115c may be associated with the content alliance system 100 of FIG. 1.

As illustrated, member 115c may act as both a promoter 210 and a publisher 215 of content. For example, as a promoter 210, member 115c may send or spend points in order to show content on other k member websites or other content mediums at 220, for example, by selecting one or more content spaces via the host 120. Additionally, member 115c may act as a publisher 215 of content, for example, by earning points for presenting content of other members on a website or other content medium of the member 115c at 225. In this way, member 115c may promote its own content and present the content of other members 115 without having to interact with separate publishers 110 and promoters 105. Using the content exchange system 100, members 115 may be able to reduce time, necessary communications with other entities, and cost associated with promotion of content.

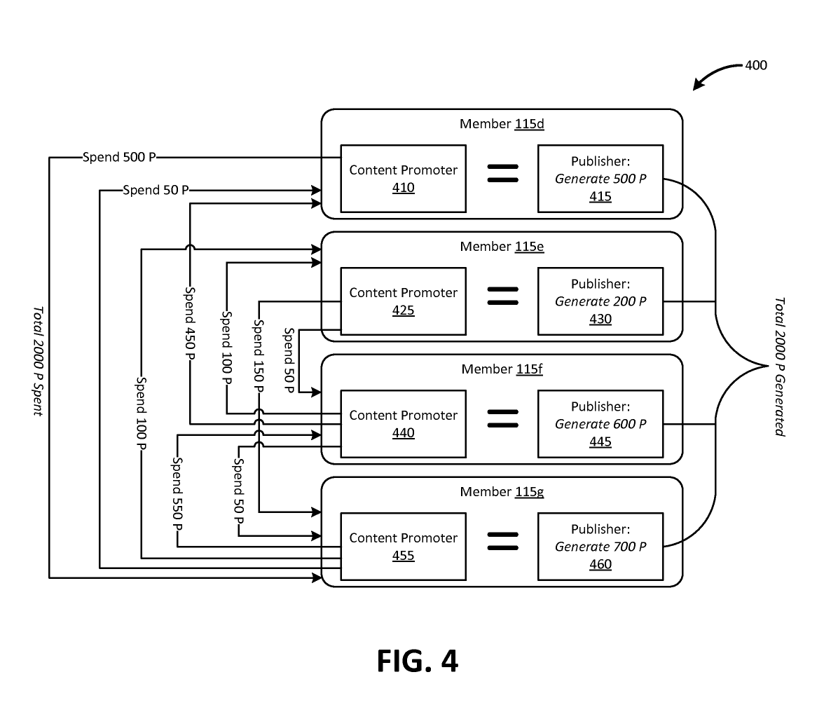

FIG. 3 shows an example of communications 300 between a host and a web page associated with a member of a content exchange system, according to the described techniques. A member, such as member 115, may associate with a content exchange system, such as system 100, via a host 120b. In some cases, the host 120b may be implemented on one or more servers, computing devices, etc. The member 115 may associate one or more content mediums, such as a web page 305, multiple web pages, websites, etc., that may be identified via one or more domain names, with a member account. The member 115 may designate one or more content spaces on the web page 305 for use by other members 115 of the content exchange system. When the web page 305 is visited, for example, by someone or an entity other than member 115, the member 115 may accumulate or earn points, for example, based on a point value assigned by the host 120b to each content space.

In some examples, a web page 305 may send a request 310 to the host 120b for content to be displayed on the web page 305 upon detecting that web page 305 has been viewed or accessed (e.g., visited). In some cases, the sending of the request 310 may be initiated or directed by instructions or program code embedded in the web page 305. In some cases, request 310 may include the identity of the member 115 associated with the web page 305 and location information of what areas of the webpage 305 were viewed by the visitor. The request 310 may additionally include information relating to content spaces designated by member 115 associated with web page 305, for use by other members. Upon receiving request 310, the host 120b may send relevant content associated with other members at 315 to web page 305. In some cases, the host 120b may select which content to send at 315 based on profile information associated with the member, the location information, and/or available content space information. The profile information may include a type of business/industry the member 115 is associated with. With the content sent at 315, the host 120b may also send a request, e.g., in the form of program code or instructions, for location information associated with the one or more content spaces and page scroll information associated with one or more content spaces, for example if this information was not included in the request 310.

Once the web page 305 has received the content and the request 315, the content associated with other users or members will be displayed on web page 305. The web page 305 may then send location and page scroll information of the content spaces presenting the content at 320. The host 120b may allocate points to the occupied content spaces to be given to or associated with the member 115. In some cases, if the presented content is not visible or not viewed by a visitor via scrolling, for example, the point value for the content space may be reduced and/or set to 0, if, for example, there is a high probability that a visitor to the web page 305 will not see the content. In this way, points may be granted to the member 115 for presenting other members' content on web page 305, in proportion to visibility and traffic on the web page 305.

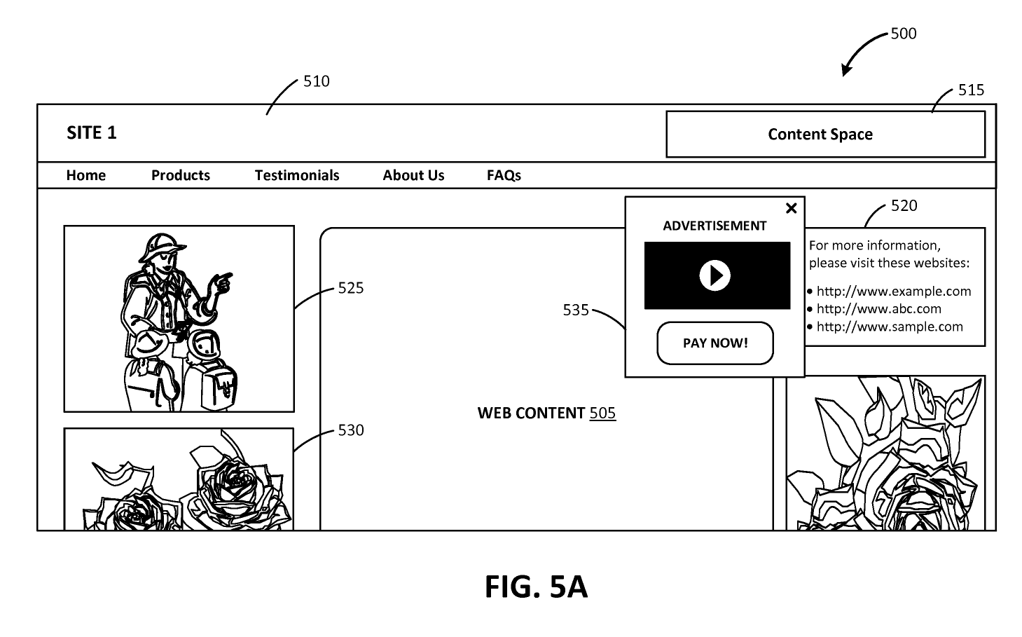

FIG. 4 illustrates a block flow diagram 400 of an example of points exchanged between multiple users of a content exchange system, in accordance with the present disclosure. In the example shown, 4 members, members 115d, 115e, 115f, and 115g may earn and spend points by presenting content of other members and promoting their own content on content space of other members. Each member 115 may be associated with a content promoter aspect, function, identity, etc. and a publisher aspect as well. For example, member 115d may include a promoter aspect 410 and a publisher aspect 415, member 115e may include a promoter aspect 425 and a publisher aspect 430, 115f may include a promoter aspect 440 and a publisher aspect 445, and 115g may include a promoter aspect 455 and a publisher aspect 460. It should be appreciated that a content exchange system may include any number of members, spending and generating any number of points. The details of FIG. 4 are only given by way of example. Furthermore, other metrics besides points may be used to implement the concepts described herein. In one example, content viewed points or advertisement viewed points (AVP) may be used.

As illustrated, member 115d may generate 500 points, by presenting content of member 115f (450 points) and content of member 115g (50 points). In some cases, member 115d may first accumulate points by presenting other members' content on a website associated with member 115d, before being able to spend points. In other cases, after a point value is determined for one or more content spaces associated with a website of member 115d, the point value, modified or multiplied by a length of time or selected views, may be associated with member 115d upon selection of the content space by another member. In this scenario, upon selection by another member, member 115d may have access to spend the earned points. In either case, upon earning the 500 points for presenting content associated with members 115f and 115g, member 115d may spend 500 points to present its own content on a website of member 115g.

In a similar way, member 115e may generate 200 points including 100 points from member 115f and 100 points from member 115g. Member 115e may then spend the generated 200 points, for example by promoting its content on content spaces associated with member 115f (50 points) and member 115g (150 points). Member 115f may generate 600 points including 50 points from member 115e and 550 points from member 115g. Member 115f may spend the generated 600 points, for example, by promoting its content on content spaces associated with member 115d (450 points), member 115e (100 points), and member 115g (50 points). Similarly, member 115g may generate 700 points and spend those 700 points, for example, by promoting its content on content spaces associated with member 115d (50 points), member 115e (100 points), and member 115f (550 points).

In the example shown, the total number of points spent (2000) equals the number of points generated (2000). The content exchange system may track each point that is generated or earned, each point that is spent or used in a content space selection, and ensure that only up to the number of points generated are spent. Stated another way, the content exchange system may balance the point spent and the points earned. This may be to ensure that every selection of content space for promotion on another member's website may be honored.

In some examples, the point balancing function or capabilities of the content exchange system may be more complex. For example, content selections may be given a point value based on the amount of time the selection is valid for, e.g., how long the content promotion will run or be activate on the selected content space. In this example, the content system may track points generated and spent in real time, and map the available points according to the expiration of each selection. In this way, available content space selections may be updated upon any content-related event in the content exchange system, including expiration of a selection of a content space, generation of new content spaces by existing members, new members joining the content exchange system, and so on.

In another example, content selections may be given a point value based on how many times the content space is viewed or accessed. In this scenario, it may be more difficult to know exactly when content spaces will become available for selection, for example, because a certain number of views may take a varying length of time to occur. The content exchange system may project a length of time in which a certain number of views of a content space will occur, for example based on historical information related to that particular content space, the website associated with the content space, the time of year, industry sales information, etc. In this way, a relatively accurate approximation of when additional points will be available may be made and communicated to members 115.

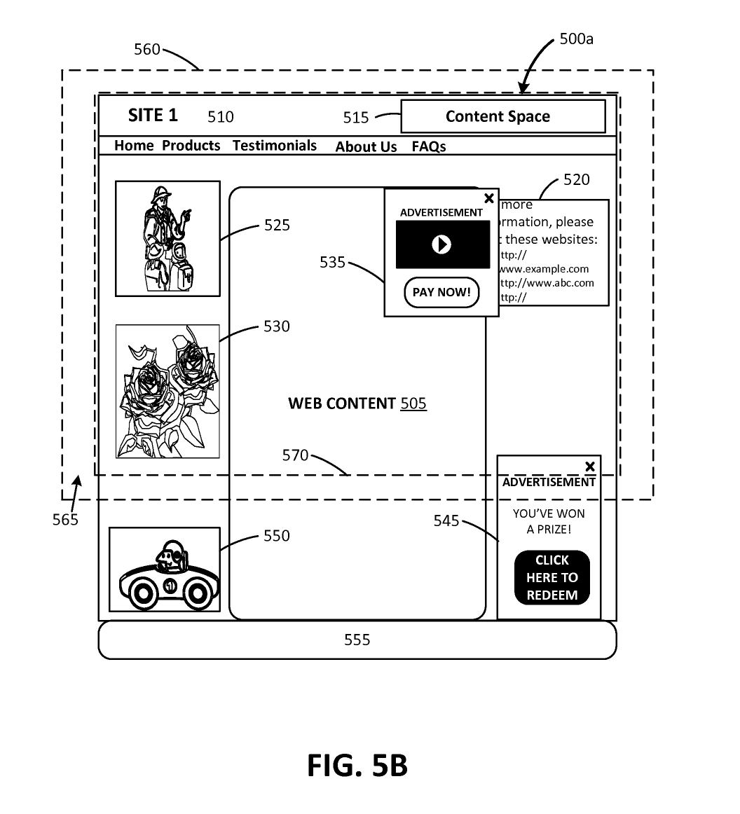

With reference to FIG. 5A, an example web page 500 is shown with multiple content spaces, in accordance with the described techniques. In the example illustrated, web page 500, which may be an example of web page 305, may include an associated member's web content 505, having a top banner section or portion 510. A member associated with the web page 500 may designate one or more content spaces, such as content spaces 515-535, to be associated with a content alliance system (e.g., system 100). In some aspects, the member may select from a predetermined list of sizes and configurations of content spaces to allocate to web page 500. The content spaces may include any of slogan or sticky type content, animation content, text content, video content, etc. In some aspects, the content alliance system may allocate a certain number of points to each content space based on, for example, size, location, type, views or likely views of the content space, etc. For example, a certain number of points, such as 10, may be associated with a content space 515 in the top banner portion of the web page 500. Other content spaces may also be included or designated on web page 500, such as content spaces 520, 525, and 530, which may be generally located on the sides or peripheral of the web page 500. As these content spaces may not demand a viewer's attention, for example, to the extent of the top banner 515, these content spaces may be associated with less points, such as 5 points. In some cases, different point values may be associated for text-only content, such as content space 520, compared with image-based content, such as included in content spaces 525, 530. In yet some examples, one or more content spaces may be associated with video or streaming video, such as content space 535. Content space 535, for example, may be associated with a greater number of points, such as 20, based on a higher likelihood that a viewer of web page 500 will retain information associated with content space 535. Additionally or alternatively, one or more designated content spaces may be pop-up spaces, or spaces unassociated with a fixed location relative to web page 500. These content spaces may be associated with an even high value. In the example shown, content space 535 contains video content and is a pop-up space; as a result, this content space may be allocated 30 points.

The above content space points and positions are given only as examples. It should be appreciated that other point schemes and other content space placements are contemplated herein.

With reference to FIG. 5B, another example web page 500a is shown with multiple content spaces, in accordance with the described techniques. Web page 500a may include similar content and content spaces as web page 500 described above, but may include more content and content spaces, for example, below the content of web page 500. Accordingly, web page 500a may be larger than a view screen 560, for example, of a monitor or mobile device display. A browser window 570, for example, associated with an internet browser, may be a different size than screen 560 and may further limit the amount of webpage 500a that a viewer may view at one given time. In some aspects, a space 565 may be generated between the screen 560 and the browser window 570, which may show other device related content or applications (e.g., one or more computer controls, a clock, etc.). Because the web page 500a may be larger than a viewable screen 560 or a browser window 570, some web content 505 and some content spaces 550, 545, and 555 may not be viewed by a visitor to the webpage 500a, for example, if the web page 500a is not resized or moved to view the additional content. In other cases, one or more content spaces 545 may only be partially visible without scrolling the browser window 570. In any of these cases, the point value of the content spaces 545, 550, and 555 (e.g., points associated with the content space for each view by a visitor, or the cost to display content in the content space) may be less than content spaces 515, 520, 525, 530, and/or 535, due to the amount each is actually viewed.

In some aspects, more points may be associated with content spaces 515, 520, 525, 530, and/or 535 than with content spaces 545, 550, and 555, for example based on their position on webpage 500a. In some cases, a point value may be associated with content spaces based on views of the particular content spaces. In one example, actual views of a content space may be determined using position or location information of the content space, the web browser 570 and/or the screen 560 size, and/or scroll or movement activity associated with the browser window 570. In one example, no points will be given to the owner of webpage 500a for content space 550, for example, if a visitor does not scroll down or otherwise move the browser window 570 to display the content space 550. In another example, the owner of webpage 500a may receive some or all of the points associated with one view of content space 545, for example, if 50% or more of the area of content space 545 is visible in the browser window 570. In other examples, any other threshold values or metrics may be used to reduce points received for only partial views of a content space. In some aspects, the owner of each content space may be given points for each access of the content space. Each access may be determined, for example, based at least in part on, one or more of a content space size, a content space location, a browser window size, a browser window location, and/or a browser window movement.

In one aspect, when web page 500a is initially visited and displayed, a request for a content item to be displayed via a content space on web page 500a may be sent to the web server (“server”). The server may then instruct the web page 500a to determine if the content item is visible on the visitor's screen 560/browser 570. If the content space is not initially visible, the web page 500a (or the server) may continue to check to see if the content space falls within the screen 560/browser window 570, for example, each time the web page 500a is scrolled or the browser window 570 is resized. Once the content space is made visible in screen 560/browser window 570, the web page 500a may either associated points to the owner of web page 500a, or instruct the server to do so. In some aspects, the web page 500a may be instructed to determine if a content space is actually viewed by a visitor, for example by instructions in the form of code, sent from the server.

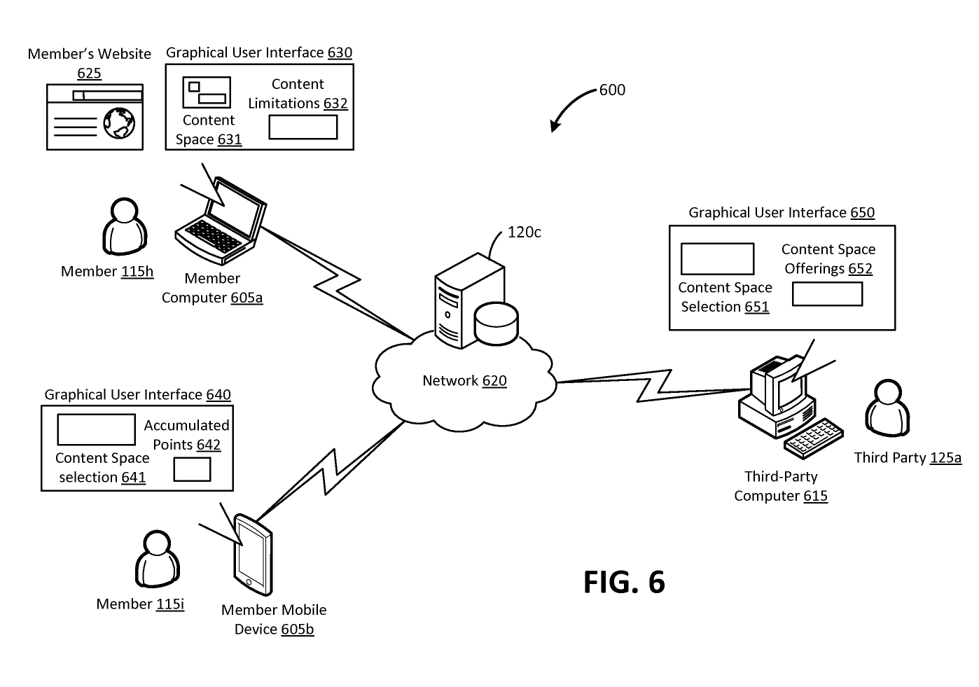

FIG. 6 shows an example content exchange system 600, including any number of member computers, mobile devices, or other computing devices 605a, 605b, a host device or server 120c, and a third party computing device 615. In the example shown, a host 120c may communicate with member computer 605a, member mobile device 605b, and third party computer 615 via a network 620. Network 620 may include a wired or wireless network, for example utilizing one or more cellular networks, wireless local area networks, local area networks, etc. It should be appreciated that other numbers of members, third parties, or even hosts are contemplated herein, using similar techniques.

In one aspect, a member 115h, may access a content exchange network interface or graphical user interface 630 via member computer 605a, facilitated by communication with the host 120c. Member 115h may also access a web page or website 625 associated with member 115h. In some cases, member's website 625 may display content, for example, one or more content spaces (not shown) utilizable by one or more other members of the content exchange network 600. In this way, member 115h may have already, and/or be currently accumulating or earning points via views of the member's website 625.

Member 115h may access account information associated with the content network 600 via the graphical user interface 630. In some examples, member 115h may access information relating to allocating content spaces 631 on member's website 625 for use by other members, for example to earn more points/earn more points faster. Member 115h may also access and define certain content limitations 632 for the content spaces member 115h is allocating for use by other members. For example, member 115h may specify that the allocated content spaces may not be associated with the same or similar industry as member's website 625. Additionally or alternatively, member 115h may designate a variety of other restrictions for the content spaces, for example including maximum time limitations, minimum time limitations, limits on repeated use of one or more content spaces, and so on. In this way, member 115h may utilize a content network interface 630 to control content space allocations and easily manage resources that will be available for content promotion.

In some examples, member 115i may access graphical user interface 640 via member mobile device 605b, also facilitated by host 120c via network 620. Member 115i may wish to select one or more content spaces of other users/members for promotion of member's 115i content. Graphical user interface 640 may display a content space selection 641 to member 641. Via the content space selection 641, member 115i may browse and/or select available content spaces associated with other members for promotion of member's 115i content. In some cases, member 115i may view all available content spaces in the content exchange system 600. The graphical user interface 640 may also display an accumulated points section 642, where the member 115i may view, verify, etc., the points that have already been previously earned by member 115i.

In some examples, a third party 125a may access a third party graphical user interface 650 through a third-party computer 615, facilitated by host 120c via network 620. After associating with the content exchange system 600, the third party 125a may access one or both of the content space selection portion 651 or the content space offerings portion 652, depending on whether the third party is registered as a promoter, a publisher, or both. With promoter privileges, the third party 125a may select one or more content spaces associated with one or members for promotion of third party content via content space selection 651. Content space selection 651 may be very similar to content space selection 641, but in some cases may display a points-equivalent value for selection of content space. In some cases, the third party 125a may purchase points from the host 120c and/or from one or more members.

With publisher privileges, the third party 125a may designate one or more content spaces associated with a website or other content medium of the third party 125a for use by one or more members of content exchange system 600. In this scenario, the third party 125a may access, designate, and/or set limitations of content space offerings via content space offerings portion 652.

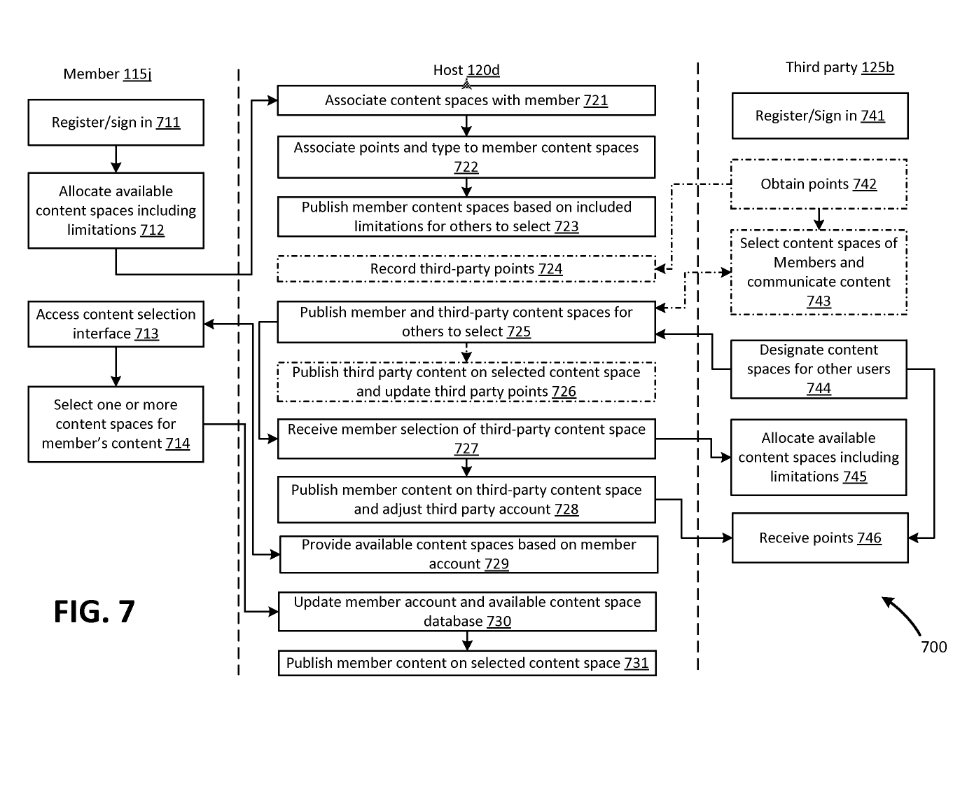

With reference to FIG. 7, a block flow diagram 700 shows various processes associated with a content exchange system or network, as described above. For ease of reference, only one member 115j, one host 120d, and one third party 125b are shown; however, it should be appreciated that the described processes are applicable to any number of users of a content exchange system or network. As described below, operations performed by member 115j may be received by or associated with a member computer 605a, 605b, and operations performed by third party 125b may be received by or associated with a third party computer 615.

In one aspect, a member 115j may allocate content spaces available for use by other members/third parties, for example using one or more computing devices 605b and/or GUI 630. First, a member may register or sign in at 711 to a system interface. Next, member 115j may allocate available and/or desired content spaces associated with a content medium or website of the member 115j, including any limitations associated therewith at 712. The member device 605 may send the allocation information to the host 120d. In response, the host 120d may associate one or more content spaces with the member 115j at 721. Next, the host may associate a point value and type of content space (e.g., banner, side, pop-up, video, etc.) to the member content spaces at 722. The host 120d may publish the member content spaces including any designated limitations for other members/third parties to select at 723. The available content space selections may be periodically updated, for example, by the host 120d, and sent to one or more members 115/member computing devices 605. In this way, members of the content system may have updated section material to provide more content presentation, and spend and accumulate more points. This may in turn create more exposure for the content system/network as a whole, and potentially persuade more members to join, thus increasing the value of the content spaces, and in turn creating more exposure/views of the content spaces. The content network may thus grow in this manner and provide even more value to members.

In another aspect, member 115j may wish to promote content associated with member 115j on other members' or third parties' content spaces. Accordingly, member 115j may access a content selection interface at 713, for example content space selection 641 via GUI 640. The host 120d, upon receiving a request to access the content selection interface, may provide available content spaces to member 115j based on member's 115j account at 729. In some cases, host 120d may provide all available content space sections at 729. Next, member 115j may select one or more content spaces upon which to promote member's 115j content at 714. The host 120d may receive the request and update member's 115j account and the available content space data system-wide at 730. The host 120d may then publish member's 115j content on the selected content spaces(s) at 731.

In another aspect, a third party 125b acting as a promoter may register/sign in to the content system at 741. Next, the third party 125b may obtain points, for example via purchasing one or more points according to a value set by the host 120d. The host 120d may subsequently record the third-party point allocation at 724. In some cases, a third party 125b may already have purchased or received a number of points. In this case, the third party 125b may access point information via host 120d in place of or in addition to steps 742 and 724. The host 120d may publish, either upon request, periodically, etc., member and third party content spaces available for selection at 725. Third party 125b may access, browse, and select one or more available content spaces associated with one or more members at 743. The third party 125b may also communicate the content for presentation at 743. The host 120d may subsequently publish the received third party content on the selected content space(s) and update the third party point allocation/account at 726.

In another aspect, the third party 125b acting as a publisher may register/sign in to the content system at 741. The third party 125b may then designate content spaces for use by members/promoters at 744. The host 125b may then publish member and the third party content space designations for others to select at 725. The host 120d, may at any later time, receive a member, or a third party promoter's, selection of one or more third party content spaces at 727. The host 120d may publish the member content on the third party content space(s) and adjust the third party account accordingly at 728. The third party 125b may subsequently receive points/compensation at 746.

In one aspect, for example when available points become limited, the host 120d may obtain points from one or more third parties 125b. In some cases, for example if the content system becomes very popular, available content space may become limited. In order to ensure that members 115 have enough access to the content system, the host 120d may obtain points from third parties 125. In other cases, for example when content space associated with members 115 is underutilized, the host 120d may grant points to third parties 125, for example to stimulate more content space usage and/or to balance points in the content system.

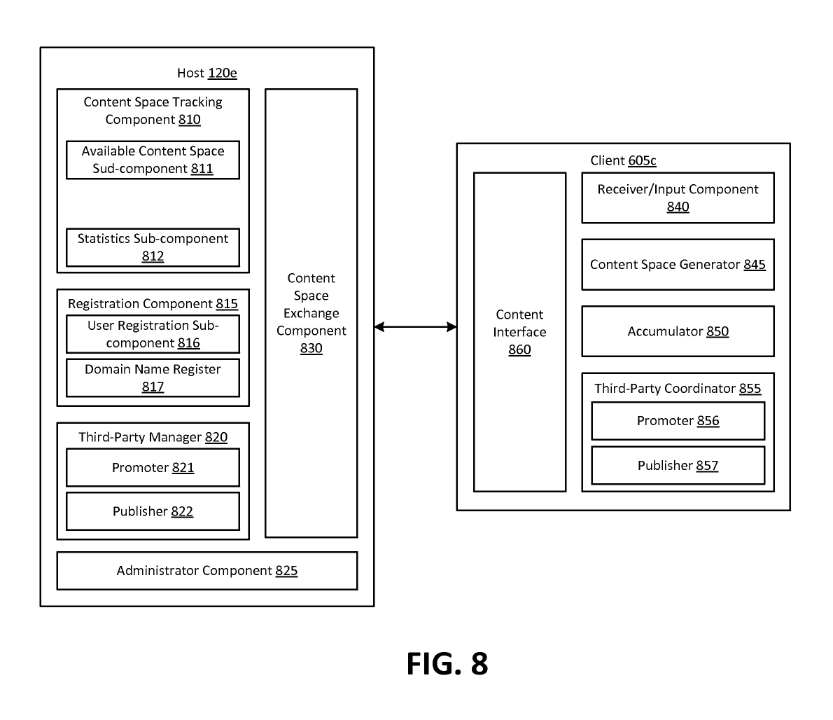

With reference to FIG. 8, an example host 120e in communication with an example client device 605c is shown. In some aspects, the host 120e may be associated with one or more servers, one or more computing devices, or a combination thereof. The client device 605c may be associated with a mobile device, laptop, computer, or other computing device. Host 120e may include one or more aspects of host 120, 120c, or 120d as described above, and may incorporate aspects of process 700. Similarly, client device 605c may include one or more aspects of member computer or device 605a, 605b or third party computer 615 as described above, as well as being associated with any of members 115, member web page 305, or one or more third parties 125. Additionally, client device 605c may implement one or more aspects of process 700.

In one aspect, host 120e may include a content space tracking component 810, a registration component 815, a third party manager 820, and a content space exchange 830, all in communication with one another. In some cases, host 120e may also include an administrator component 825. In some cases, the registration component 815 may include a user registration sub-component 816 that may register a plurality of members with a content exchange system, for example, upon payment of a fee and establishment of a member profile. Once a user is registered, a domain name register 817 may receive information from a user, designating one or more domain names with the account. In some cases, the registration component 815 (e.g., the user registration component 816 and/or the domain name register 817) may verify member and domain name information before registering a member. Upon registering, a member may access the content exchange system by logging in via the registration component.

In some cases, the content space tracking component 810 may include an available content space sub-component 811 that may receive, for example, via receiver/input component 840 of client 605c, one or more designations of available content space from the member. The available content space sub-component 811 may maintain a record of available content spaces from multiple members of the content exchange system. In some cases, the content space tracking component 810 may associated a point value to each available content space. The content space tracking component 810 may track views of each content space. The content space tracking component 810 may allocate the designated number of points for each content space associated with member or client 605c each time the content space is accessed or viewed, for example by another person, company, etc. The content space tracking component 810 may then communicate or pass this information to content space exchange 830, which may generate one or more content space selections for a member, for example via client device 605c. In some aspects, administrator functionality, e.g., maintaining the system, blocking members from the content exchange system for abuses, etc. may be provided by the administrator component 825.

In some cases, the content space tracking component 810 may maintain a total number of available points for each member based on the points allocated to each member and selections made by each member. A statistics sub-component 812 may, in some cases, generate and provide point statistics information for one or members 115, such as via content space exchange component 830 and/or client device 605c. In some cases, the content space tracking component 810 may communication this information to the content space exchange 830, which may in turn generate one or more selections for the member via client device 605c based on available for points associated with the member.

The host 120e may in some cases include a third party manager 820 that handles registration and intake of relevant information from one or more third parties, for example in a promoter capacity via promoter sub-component 821 and/or as a publisher via publisher sub-component 822. In some cases, the promoter sub-component 821 may associate one or more promoters with the content exchange and communicate promoter information to the content space exchange component 830. The content space exchange component 830 may subsequently generate at least one promoter content space selection associated with at least one of the members 115 based on availably, and present this information to a third part 125, such as via client device 605c or a third party computer 615. In some cases, the available content space sub-component 811 may determine if content space is available, for example, for one or more promoters (or members), based on a total number of content spaces or points associated with the plurality of members, a number of selected content spaces or used points associated with the plurality of members, or a number of available content spaces or available points associated with the plurality of members.

In some cases, the publisher sub-component 822 may associate one or more publishers with the content exchange system and communicate publisher information to the content space exchange component 830. The content space exchange component 830 may subsequently generate at least one publisher content space selection of publisher content space associated with, and present this information to one or members 115, such as member 115 via client device 605c.

In some aspects, a client device 605c may share some or all of the functionality of a host device 120e in hosting a content exchange system. In some cases, client device 605c may maintain records in memory associated with one or more members 115, and may communicate this information to the host 120e via one or more networks, for example when received, periodically, et. The example client device 605c may include a receiver/input component 840, a content space generator 845, an accumulator 850, a third party coordinator 855, and a content interface 860, all of which may be in communication with each other.

In one example, the receiver/input component 840, which may include one or more input devices such as a keypad, keyboard, touch screen, and so on, may receive an allocation of one or more content spaces available for use from a member 115. In some cases, the one or more content spaces may be associated with the first member's website, or other content medium. The content space generator 845 may generate the allocated content spaces and allocate a number of points to each space. The point value may be based on size, location, or type of the content space, for example as described above in reference to FIG. 5. The accumulator 850 may accumulate or tracks points for the content spaces associated with the first member, for example, each time the content space is viewed or accessed. The content interface 860 may, after the first member has accumulated points, generate at least one selection of a content space associated with a second member, for example, in proportion or based on the number of points accumulated by the first member. In some cases, the content interface 860 may generate selections associated with all available content spaces associated with the content exchange regardless of whether the first member has enough points to select any given content space.

In some cases, the selection of one or more content spaces may be associated with a time period, a number of accesses, or an industry, as described above in reference to FIG. 4. In an example, the first member may select a content space of a second member on which to present content. The selection may be associated with a point value, for example, adjusted by how long the content space will be active or present the first member's content, or a number of accesses of the content space.

In some cases, the client device may include a third party coordinator 855, including a promoter sub-component 856 and publisher sub-component 857. The third party coordinator 855 may enable a third party to access the content exchange system via client device 605c. In some examples, the third party coordinator 855, including a promoter sub-component 856 and publisher sub-component 857 may include similar functionality as the third party manger 820 including the promoter sub-component 821 and the publisher sub-component 822, and will not be repeated here for the sake of brevity.

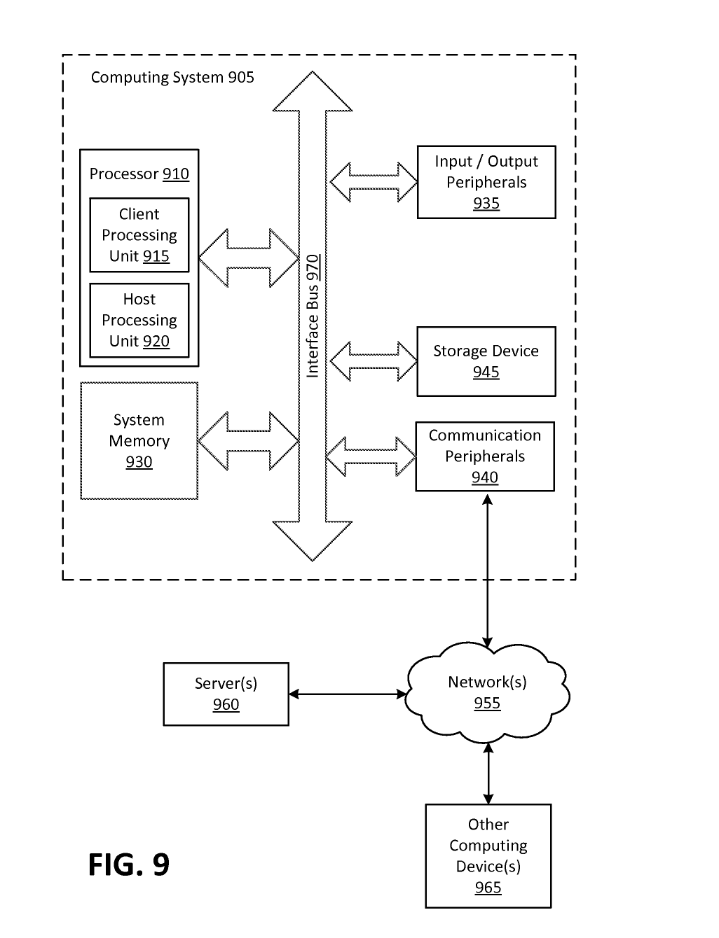

FIG. 9 shows an example computing system 905 that may be connected to one or more servers 960 and/or one or more other computing devices 965 via network 955. The computing system 905 and/or the one or more servers 960 and/or other computing devices 965 may implement and provide access/an interface to the content exchange system or platform as described above. The computing system 905, the one or more servers 960, and/or other computing devices 965, in various arrangements and configurations, may represent one or more members 115 or member devices 605, one or more third parties 125 or third party devices 615, and host 120.

In a basic configuration, the computing system 905 may include at least a processor 910, a system memory 930, a storage device 945, input/output peripherals 935, communication peripherals 940, and an interface bus 970. The interface bus 970 is configured to communicate, transmit, and transfer data, controls, and commands between the various components of computing system 905. The system memory 930 and the storage device 945 may comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory 930 may include an operation system and applications. The processor 910 is configured to execute the stored instructions and can comprise, for example, a logical processing unit, a microprocessor, a digital signal processor, and the like.

In some aspects, the processor 910 may include one or both of a client processing unit 915 and/or a host processing unit 920. The client processing unit 915 may incorporate one or more aspects of client device 605, and host processing unit 920 may also incorporate one or more aspects of host 120, as described above.

Further, the input and output peripherals 935 include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals 935 may be connected to the processor 930 through any of the ports coupled to the interface bus 970. Finally, the communication peripherals 940 are configured to facilitate communication between the computing system 905 and other computing devices 965 and/or servers 960 over a communications network 955. The communication peripherals 940 may include, for example, one or more of a network interface controller, modem, transceiver, various modulators/demodulators and encoders/decoders, wireless and wired interface cards, antenna, and the like.

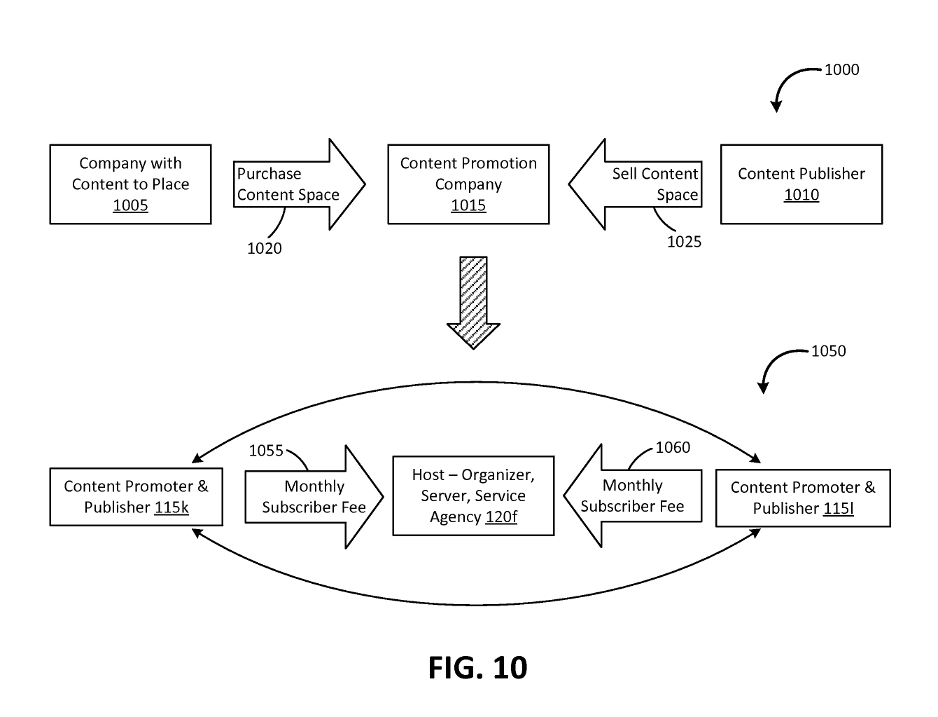

With reference to FIG. 10, a diagram shows two example business models for promoting content, including a conventional business model 1000, and a new business model 1050 provided by the content exchange system, as described above.

The conventional business model 1000 may include three main types of entities, such as a company with content to place 1005, a content publisher 1010, and a content promotion company 1015. In this model, a content publisher may sell content space at 1025 to a content promotion company 1015. A company with content to place 1005 may purchase content space at 1020 facilitated by content promotion company 1015. In this way, the content promotion company 1015 may make content space available for purchase, for example associated with a content publisher 1010, to a company with content to place 1005. The content promotion company 1015 may charge for the service of facilitating placing of content. This may result in the company with content to place 1005 paying more to place content, and/or the content publisher 1010 receiving less for promoting content of other companies. These additional costs/losses may prohibit smaller companies from entering into the content promotion space, and may place those smaller companies at a disadvantage to larger companies with larger content promotion budgets, more financial resources, etc.

The new business model 1050, using a content exchange system or platform, may alleviate some of the issues known with conventional content promotion business models. For example, multiple members 115k and 115l may act as both content publishers and content promoters by paying a monthly subscriber fee 1055, 1060 to a host 120f. The host 120 may facilitate exchange of content spaces between members 115k and 115l, for example, at no additional cost to members 115k, 115l. In this way, content space of members may be utilized and enable, for example, smaller companies and organizations to promote content.

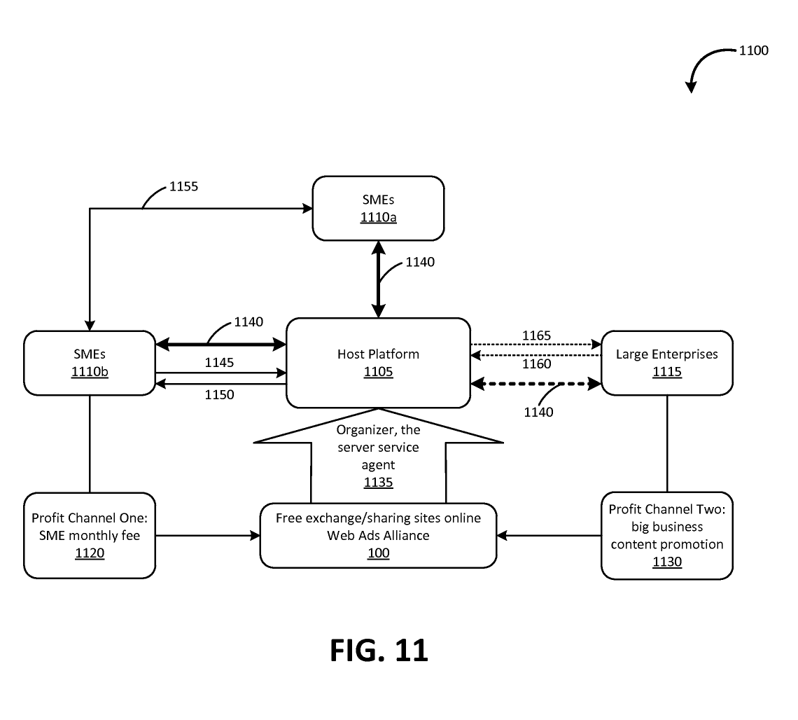

FIG. 11 shows another example of a business model and associated communications 1100 between a host 1105, SMEs or members 1110, and third parties or large enterprises 1115 created by the use of a content exchange platform, as described herein. In some examples, the host platform 1105, which may incorporate one or more aspects of host 120 described above, may create a free content exchange or alliance system 1125 (e.g., content exchange system 100) including multiple SMEs or members 1110a, 1110b (e.g., members 115). The content alliance system 1125 may generate a first profit channel 1120 including monthly fees paid by the SMEs 1110a and 1110b. In one example, an entity associated with the content alliance 1125 may organize the alliance at 1135 to be run on host platform 1105. In some cases, the content alliance 1125 may be facilitated by communications between SMEs 1110a, 1110b, and the host platform 1105. For example SMEs 1110b may pay the monthly fee at 1145 and the host platform 1105 may the generate an account for SME 1110b, grant access to points, and enable SME 1110b to publish content for other members for SMEs at 1150. In some cases, communications, for example 1145, 1150, between SMEs 1110a, 1110b and host platform 1105 may undergo a data conversion process 1140, for example, to facilitate better, faster communication of information. SMEs 1110a and 1110b may thus be able to share sites, exchange content, earn points, and generate income through content promotion at 1155 by using the content alliance 1125.

A second profit channel may include big business/third party content promotion 1130, which may include one or large enterprises 1115 (e.g., one or more third parties 125). In this profit channel, one or more large enterprises 1115 may pay for and obtain content spaces associated with the host platform and/or the content exchange 1125 via communications at 1160, 1165. Communications 1160, 1165 may also undergo one or more data conversion processes 1140, for example to enable larger enterprises 1115 to effectively communicate with host platform 1105. In this way, additional revenue may be generated by the content exchange alliance 1125, while providing for more avenues of content promotion for more and varied users, members, third parties, etc.

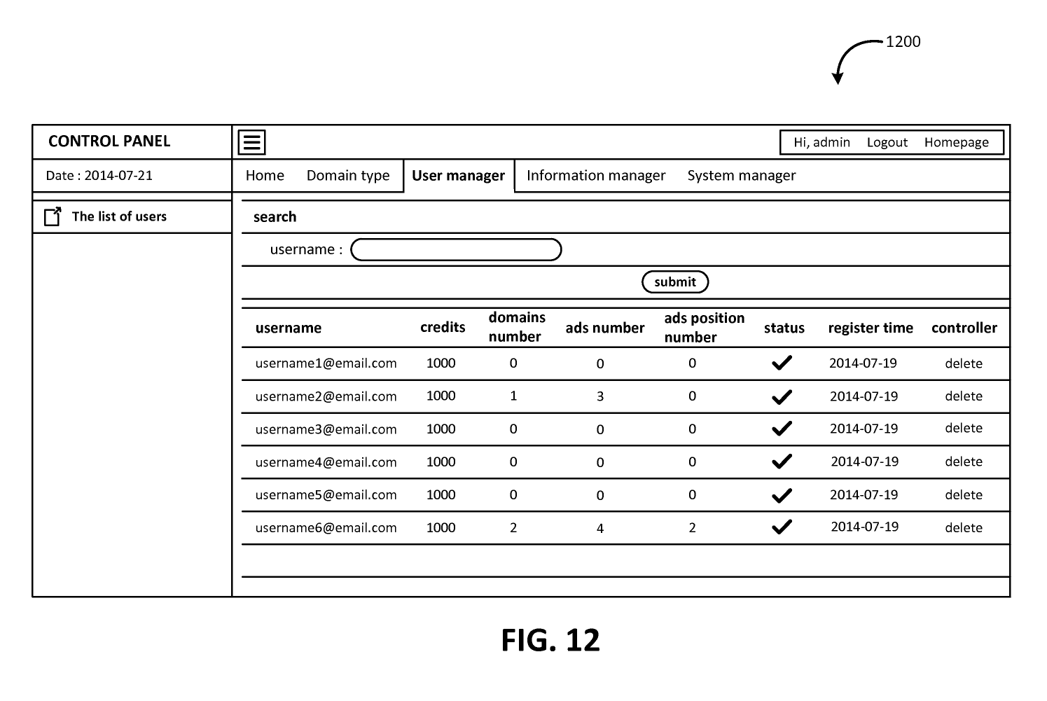

With reference to FIG. 12, a graphical user interface (GUI) 1200 associated with a host, for example host 120, is shown. The GUI 1200 may be accessed via host 120e, for example, and may represent an interface associated with the administrator component 825. GUI 1200 may display various options and selections for a host administrator to control and administer a content exchange system or platform, as described above. In the example shown, a list of users may be displayed, including points or credit information, domain name information, content spaces or advertisements (ads) information, status, register time, and an option to modify privileges or access associated with each of the users or members associated with the list. In some cases GUI 1200 may also display domain type information (e.g., domain type associated with each user or member), information manager information (e.g., relating to content promoted on various member domain names), and system manager information (e.g., including member access information and access).

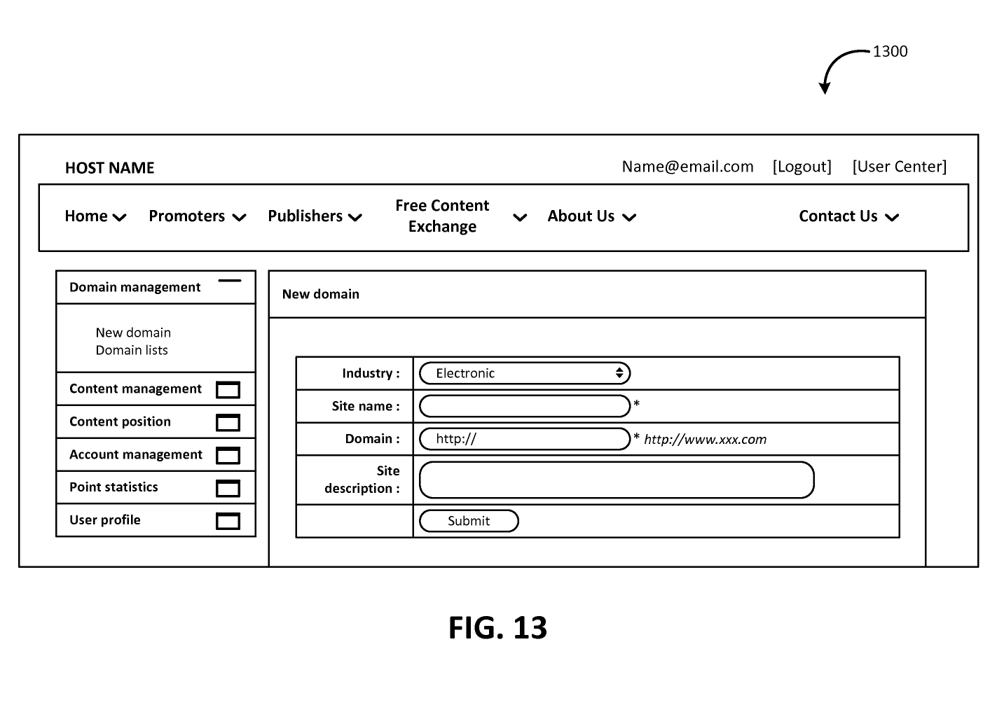

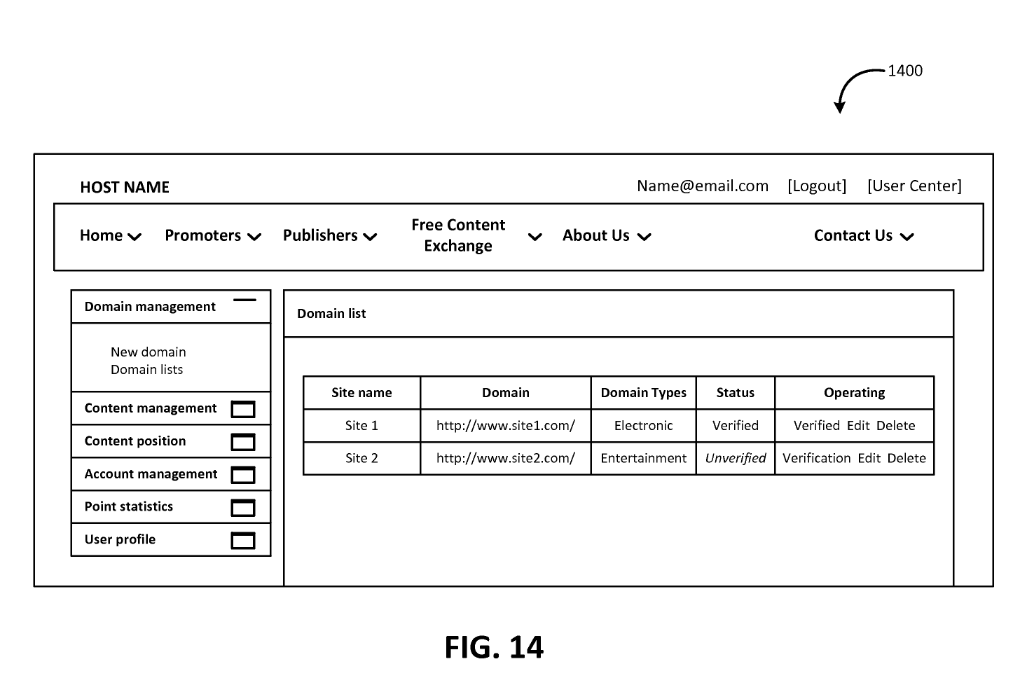

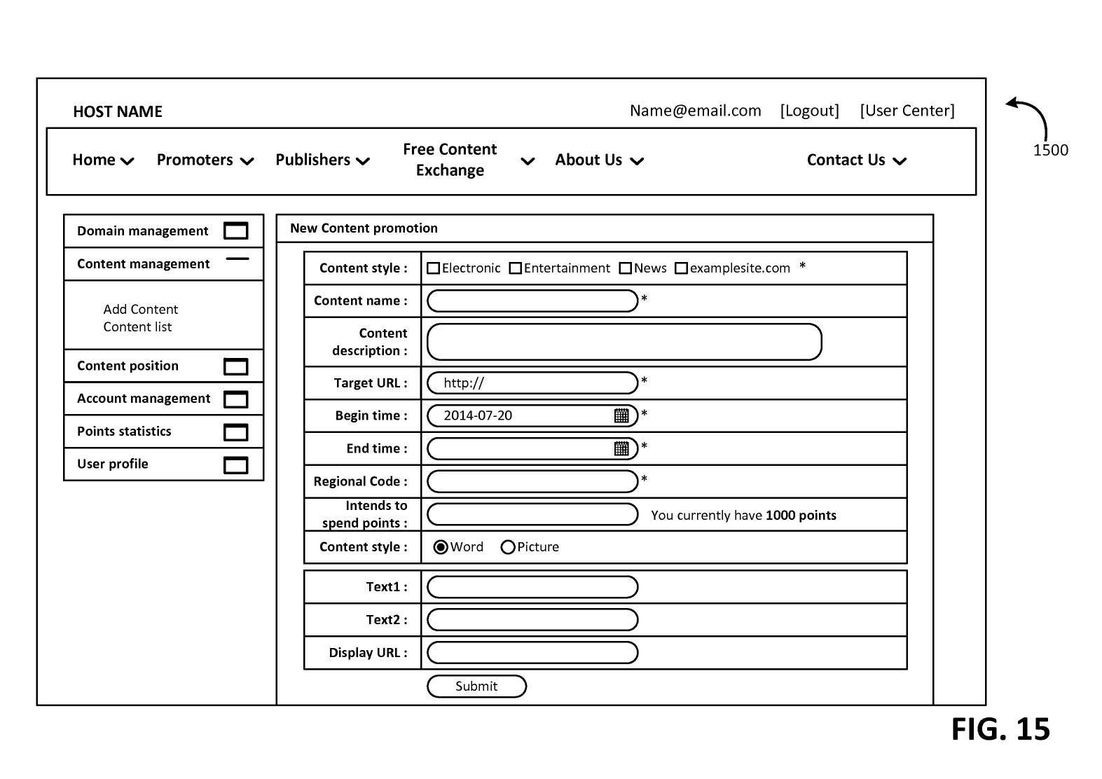

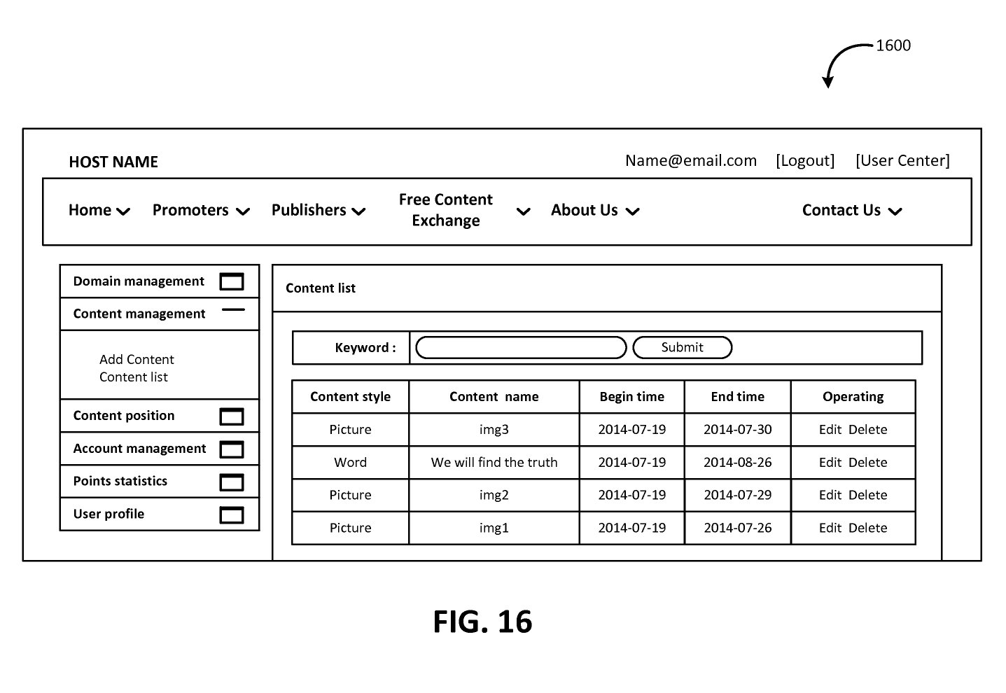

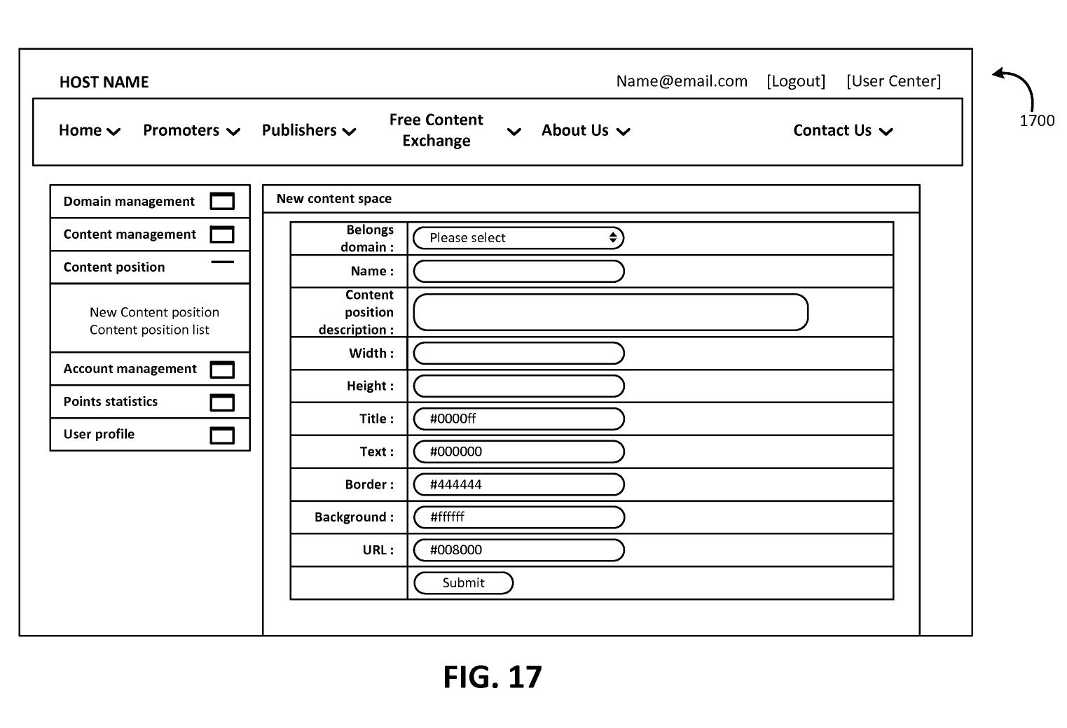

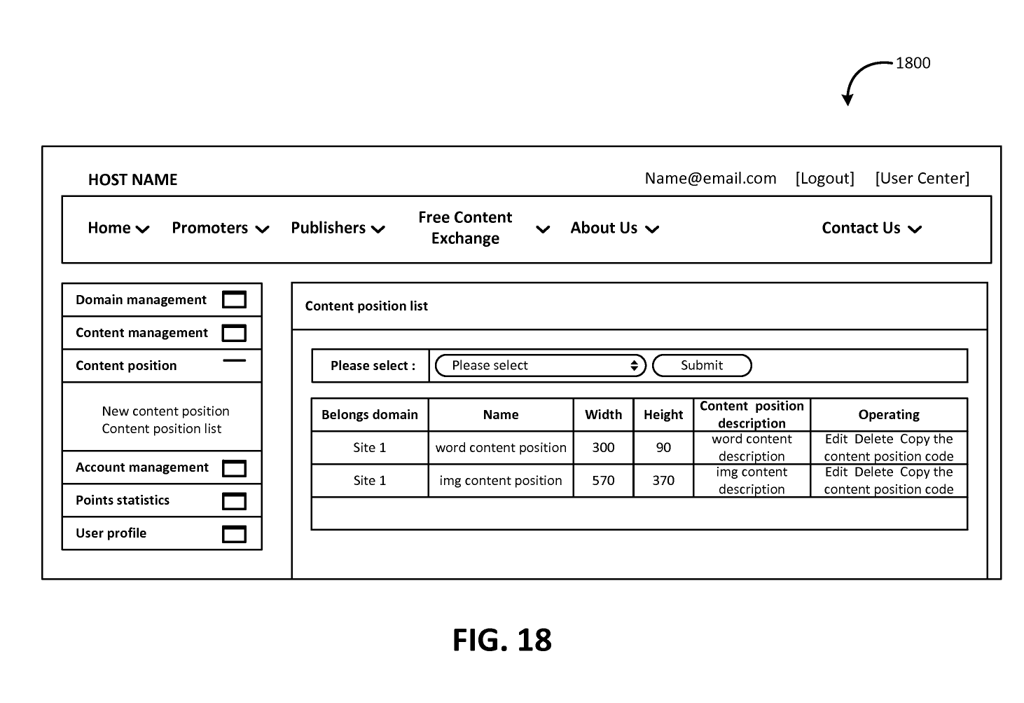

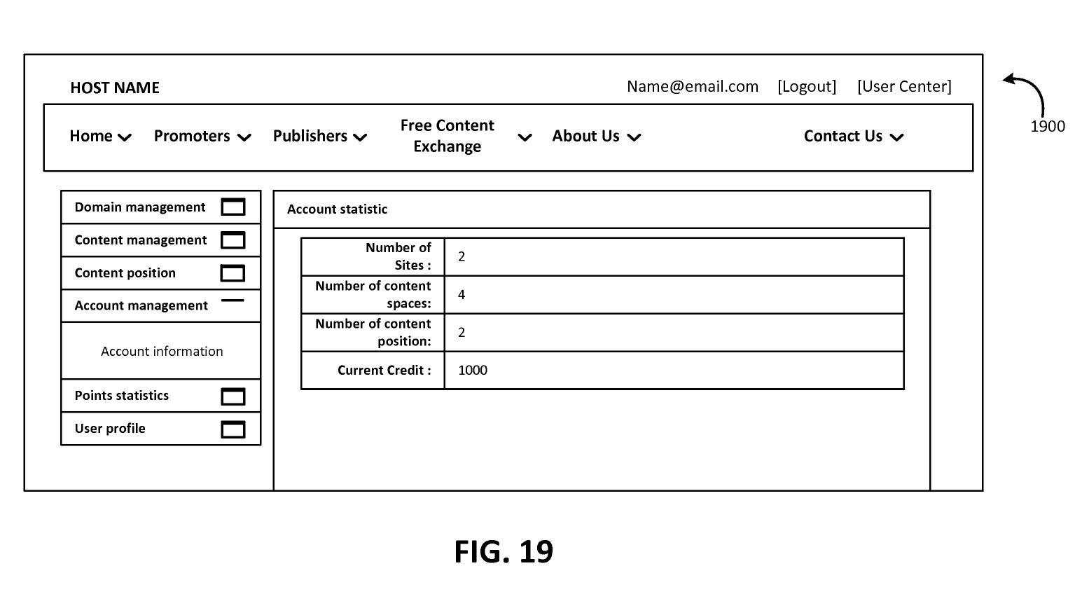

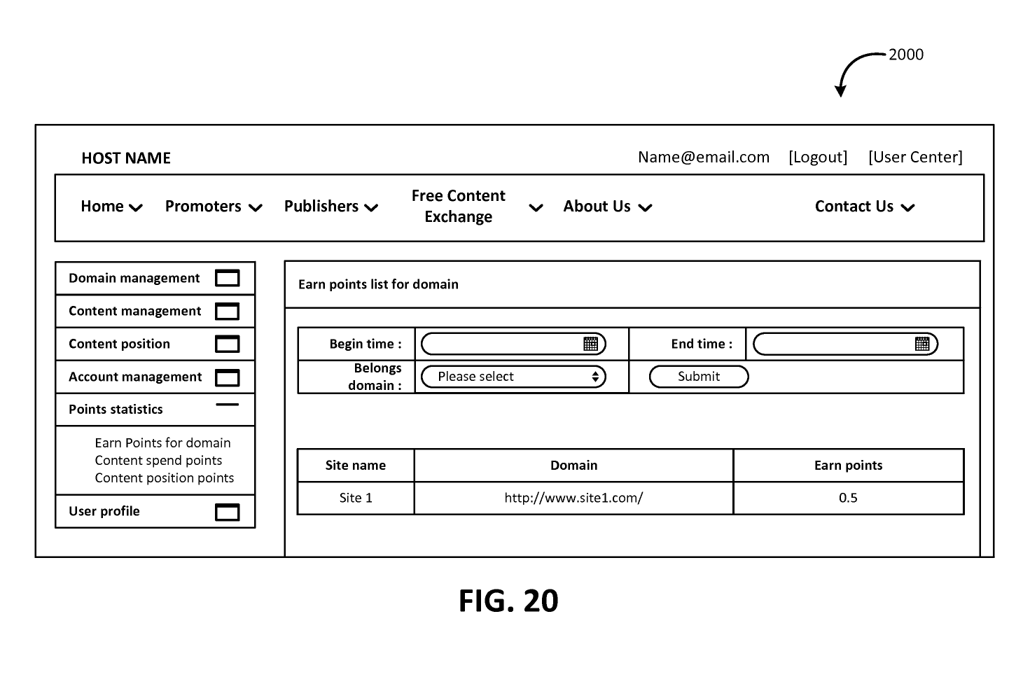

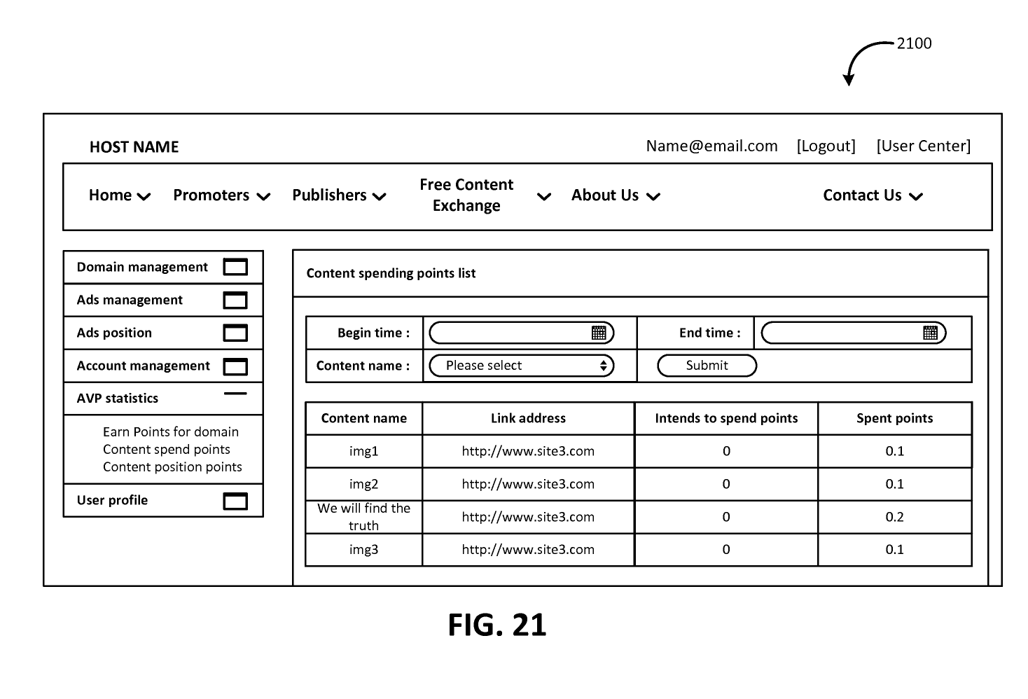

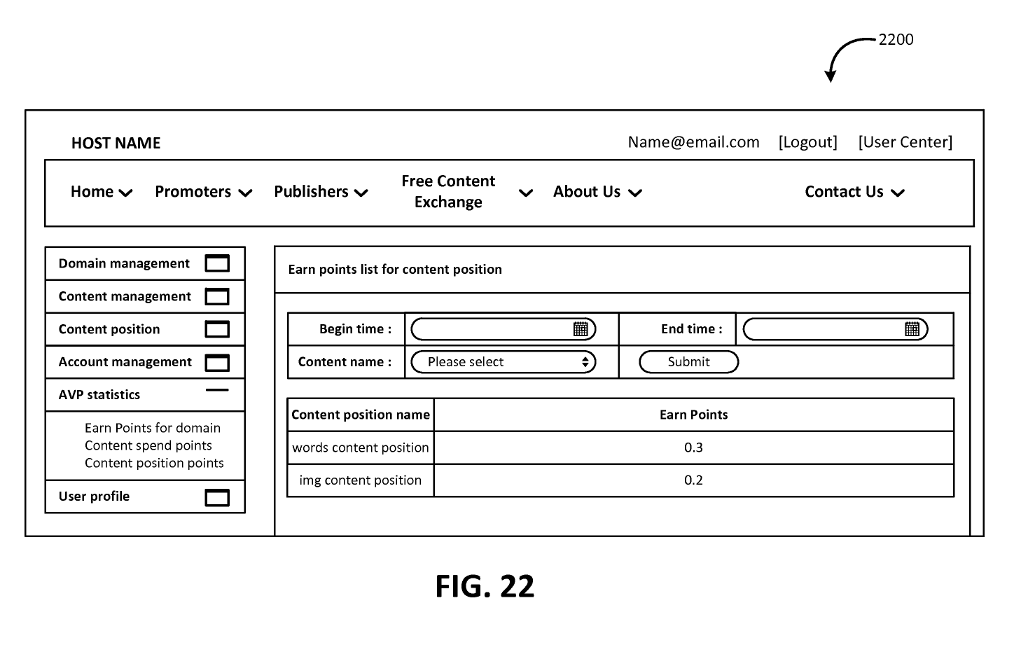

With reference to FIGS. 13-22, different aspects 1300-2200 of a GUI associated with a client device 605, for example accessed by a member 115, are shown. Aspects 1300-200 of the illustrated GUI may be an example of one or more aspects of GUI 630 and/or 640 of FIG. 6. The different aspects 1300-2200 of GUI may represent an interface created by content interface 860.

In one example, the GUI associated with a client device or interface may enable access to a content exchange system for various users, including members via a free content exchange tab, and one or more third parties through promoter and publisher tabs. The free content exchange tab may access functionality associated with the content exchange system, including domain name, content management, content position, account management, point statistics, and user profile information or selections. In some cases, the promoter or publisher tabs may access some or all of the information or selections associated with the free content exchange tab, including content management, content position, and account management functionality.

Aspects 1300 and 1400 may be an example of a domain management interface, for example, that may enable submission of domain name information, for example to be associated with a member or user. A new domain name function may enable a user or member to enter a new domain name, including type, site name, the actual domain name, and a description, and have that domain name associated with a member account, for example to enable content spaces of the member to earn points by promoting other members' content. A domain list function may list all of the domain name names associated with the member, including information, such as, the domain name, a generated site number, a type, a status (either verified or unverified, meaning that the domain name is not capable of earning points), and options to modify each domain name individually.

Aspects 1500 and 1600 may be an example of a content management interface, for example, that may enable a member to promote member content on content spaces associated with other members in the content exchange system. A user may add a new content promotion, including various information. The content promotion information may include, for example, a content style of the promotion, a content name, a content description, a target URL, a begin and end time, a regional code, points allocated for the content promotion, content style (picture or text), text of the content promotion, and a display URL, for example. This content promotion information may be used, for example, to restrict where the content promotion will be displayed, etc. A content list function may display information pertaining to content promotions that have already been obtained by the member, for example, with points already spent. Each content promotion listing may include a content style, a content name, a begin and end time (or alternatively a number of views), and operating options, such a choosing to edit or delete each listing.

Aspects 1700 and 1800 may be an example of a content position interface, for example, that may enable a member to earn points by designating content spaces associated with one or more domain names of the member for use by other members in promoting their content. A user may allocate or designate a new content space for use by other members of the content exchange system, for example by entering information associated with the new content space. The information may include an associated domain name, a name, a content position description (e.g., fixed, such as a banner or side block content space, a pop-up space, etc.), width, and height information, title, text, boarder, and background information or limitations, and a URL. The user or member may view each content space that is current allocated by the member via a content position list. The content position list may include one or more search fields, and may include itemized content spaces, with each including an associated domain name, a name, width and height information, content position description information, and operating options including the ability to edit or delete the content space.

Aspect 1900 may be an example of an account information interface, and may present to the user or member statistics associated with the member's account. The statistics may include a number of sites or domain names associated with the account, a number of content spaces, a number of content positions (allocated content spaces for others), and a current credit or point value. In some cases, other statistics may also be included.

Aspects 2000-2200 may be an example of a points statistics interface, that may enable a member to view various statistics concerning point earning and spending. In some cases, the GUI may display information relating the amount of points earned for each allocated domain, a content spending points list, including content selections and spent points associated with each content selection, and a content position points list including points earned for each content space associated with the member.

Host GUI 1200 and aspects 1300-2200 of a user GUI may thus reduce the amount of steps taken, and time needed, to select and promote content, for example via domain names of others. By placing all content selection options into a single interface, a user or member may reduce communications necessary to promote content, for example including coordinating with an outside content promoter and publisher. It should be appreciated that the descriptions of GUIs and aspects thereof, as presented above, are only given as examples. Various other information may be presented to a user or member via one or more GUIs in various different ways.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A content space processing unit comprising:
a receiver component configured to receive one or more content space allocations associated with a first user from an input device;
a content space generator configured to generate one or more content spaces based on the received content space allocations and associates a number of points to each of the content spaces based on at least one of size, location, or type of the content space;
an accumulator configured to count and store the number of points associated with each access of each of the one or more content spaces; and
a content interface configured to generate at least one selection of a content space associated with a second user in proportion to the stored number of points.

2. The content space processing unit of claim 1, further comprising determining each access of the one or more content spaces based, at least in part on, one or more of a content space size, a content space location, a browser window size, a browser window location, or a browser window movement.

3. The content space processing unit of claim 2, further comprising:
a third party coordinator configured to receive a content space request from a third user unassociated with the group, wherein the content interface is further configured to:
generate at least one third party content space selection associated with at least one of the first or second user based on availability.

4. The content space processing unit of claim 3, wherein the availability is determined based on at least one of a total number of content spaces associated with the group, a number of selected content spaces in the group, or a number of allocated content spaces in the group.

5. The content space processing unit of claim 3, wherein the third party content space selection is associated with a number of points or a point equivalent value.

6. The content space processing unit of claim 1, wherein the at least one selection of the content space is generated based on the type of content space associated with the accumulated points.

7. The content space processing unit of claim 1, wherein the one or more content spaces comprise at least one of a banner space, a side space, a video space, or a pop-up space.

8. The content space processing unit of claim 1, wherein the content interface is further configured to associate one or more of a time period, a number of accesses, or an industry to the at least one content space selection.

9. The content space processing unit of claim 1, wherein the content interface is further configured to generate a points exchange selection based on a number of points associated with the second user.

10. A content space host unit comprising:
a registration component configured to associate a plurality of users with a content exchange, wherein each user is associated with at least one content space;
a content space tracking component configured to:
receive designations of available content spaces from the plurality of users;
track views of each available content space; and
allocate points to at least one of the users based on tracked views of at least one content space associated with the at least one user; and
a content space exchange component configured to:
generate at least one content space selection for the at least one user based on the points allocated to the at least one user.

11. The content space host unit of claim 10, wherein the content space tracking component is further configured to:
maintain a total number of available points for each user based on the points allocated to each user and selections made by each user; and wherein the content space exchange component is configured to generate the at least one content space selection based on the total number of available points for the at least one user.

12. The content space host unit of claim 10, further comprising a third party manager configured to associate one or more promoters with the content exchange; and wherein the content space exchange component is configured to generate at least one promoter content space selection associated with at least one of the plurality of users based on availability.

13. The content space host unit of claim 12, wherein the availability is determined based on at least one of a total number of content spaces or points associated with the plurality of users, a number of selected content spaces or used points associated with the plurality of users, or a number of available content spaces or available points associated with the plurality of users.

14. The content space host unit of claim 10, further comprising a third party manager configured to associate one or more content publishers with the content exchange; and wherein the content space exchange component is configured to generate at least one publisher content space selection for at least one user based on the points allocated to the at least one user.

15. The content space host unit of claim 10, wherein the registration component is further configured to associate at least one domain name with each of the plurality of users.

16. The content space host unit of claim 10, wherein the content space tracking component is further configured to provide point statics to each of the plurality of users.

17. A method for generating a content exchange comprising;
receiving one or more content space allocations associated with a first user from an input device;
generating one or more content spaces based on the received content space allocations;
associating a number of points to each of the content spaces based on at least one of size, location, or type of the content space;
tracking the number of points associated with each access of each of the one or more content spaces; and
generating at least one selection of a content space associated with a second user in proportion to the stored number of points.

18. The method of claim 17, wherein the first user and the second user are members in a group, wherein the method further comprising:
receiving a content space request from a third user unassociated with the group; and
generating at least one third party selection of a content space associated with at least one of the first or second user based on availability.

19. The method of claim 18, wherein the availability is determined based on at least one of a total number of content spaces associated with the group, a number of selected content spaces in the group, or a number of allocated content spaces in the group.

20. The method of claim 18, wherein the third party selection is associated with a number of points or a point equivalent value.
